(19) United States
(12) Patent Application Publication
(10) Pub. No.: US 2007/0268307 A1
(43) Pub. Date: Nov. 22, 2007

(54) Device, Method, Software and Data Carrier Comprising Software for Displaying Information on a Screen

(76) Inventor: Michael Cohen, TM The Hague (NL)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/582,645

(22) PCT Filed: Dec. 22, 2004
(86) PCT No.: PCT/NL04/00899

§ 371 Date: Apr. 11, 2007

(30) Foreign Application Priority Data
Dec. 22, 2003 (NL) 1025098

(51) Int. Cl. G09G 5/00

(52) U.S. Cl. 345/619

(57) ABSTRACT

The present invention relates to a device comprising a memory and a processing unit for displaying information on at least one screen, comprising: first display means for displaying at least two display areas, such as a frame or a window, on the screen, second display means for displaying inside one of the display areas selectable information objects about which further information is available, selection means for selecting one of the selectable information objects, choosing means for choosing a displayed display area and/or screen in which the further information relating to the selected information object will be displayed.

The present invention relates to a device, method, software and data carrier comprising software for displaying information on a screen.

The applicant for the present patent application has for some time been supplying software which is able to display two information areas on a screen. In this software there are displayed information objects about which further information is available in the system. If a user wishes to see such further information, it is displayed in the right-hand information area after clicking on such an information object display.

In order to improve the convenience of use and/or the processing flexibility of such a system, the present invention provides a device comprising a memory and a processing unit for displaying information on at least one screen, comprising:
first display means for displaying at least two display areas, such as a frame or a window, on the screen,
second display means for displaying inside one of the display areas selectable information objects about which further information is available,
selection means for selecting one of the selectable information objects,
choosing means for choosing a displayed display area and/or screen in which the further information relating to the selectable information can be displayed.

An advantage of such a device is that systems with information areas can be operated flexibly in simple manner. With the present development of larger screens, a plurality of information areas can be realized on a screen. It is also possible to provide such a device with more than one screen, whereby the information areas to be displayed can be displayed over a larger information display area on the screens. User convenience is also great in that the user can him/herself determine in which other display area information will be shown. The user can hereby input his/her own wishes as to where which information will be displayed, whereby the user for instance quickly knows where he will be able to retrieve which information on the screen or screens.

In a preferred embodiment the choosing means comprise means for displaying a context menu. The information objects about which further information can be retrieved are marked in the output display area in a manner recognizable to the user. In a known system as described in the foregoing, after selection of the information object about which the further information has to be displayed, this further information was always displayed in the right-hand information area. Even when the information object itself was displayed in the right-hand information area, the further information relating to the information object was also displayed in the right-hand information area. The information displayed in this right-hand screen and comprising the information object was hereby overwritten by the further information of the information object. In the present embodiment the user can select a context menu by means of for instance a so-called right mouse click. In this context menu are then listed different options for displaying the further information relating to the information object. Menu options herefor are for instance a display area above or below the present display area, a display area to the left or right of the present display area or for instance a display area on another screen.

In a further preferred embodiment, the choosing means comprise means for displaying selectable icons. Such icons can function in similar manner to the selection options of a context menu as in the previous embodiment. An advantage of such icons is that the user can view the menu information in intuitive manner or by means of a graphic display. This makes the device more user-friendly.

A further aspect of the present invention provides a method for determining a second display area for displaying information relating to an information object by means of a device comprising a memory and a processing unit for displaying information on at least one screen, comprising steps for:
displaying at least two display areas, such as a frame or a window, on a screen,
displaying inside one of the display areas selectable information objects about which further information is available,
selecting an information object in a first display area,
displaying choosing means,
choosing a display area and/or a screen in which the further information relating to the selectable information will be displayed,
displaying the further information in the chosen display area.

A further aspect according to the present invention relates to a data carrier comprising a computer program which, when executed by means of a processing unit, can perform a method as specified in the foregoing.

A further aspect according to the present invention relates to software for performing a method as specified in the foregoing by means of a computer.

Advantages of these aspects according to the present invention are described above.

Further advantages, features and details of the present invention will be described with reference to the annexed figures, in which:

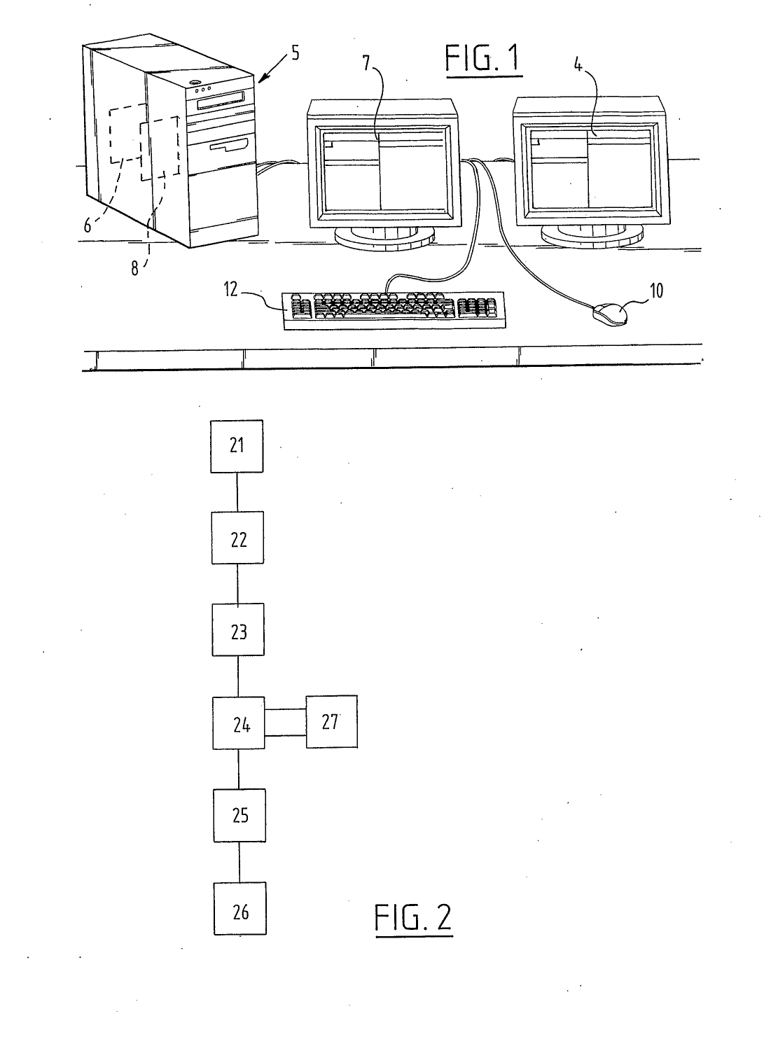

FIG. 1 shows a block diagram of an embodiment according to the present invention;

FIG. 2 is a flow diagram of a further embodiment according to the present invention.

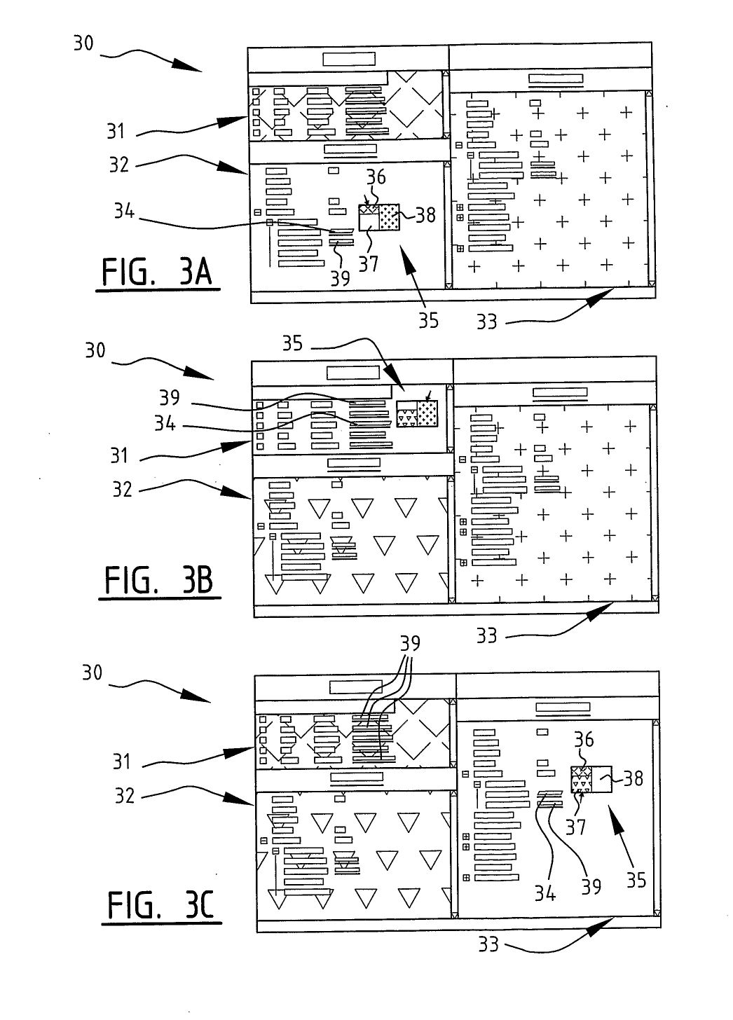

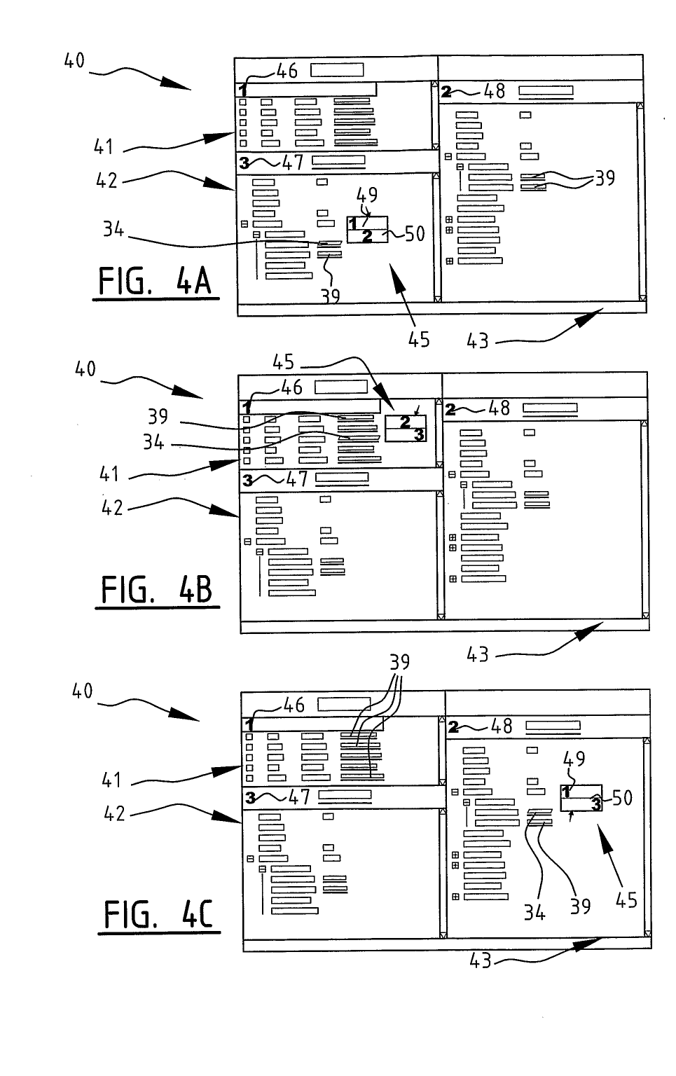

An embodiment according to the present invention (FIG. 1) comprises two screens 4,7 which are coupled to a computer 5 comprising a central processor unit 6 and a memory 8. The device further comprises a mouse 10 and a keyboard 12. Displayed on the screens are windows, which can each have sub-windows (frames). The overall screen layout of the embodiments of FIGS. 3 and 4 are shown on the screens of FIG. 1. The sub-windows can be designated with the general term of information area or display area. Such an information or display area is used to display information by means of software which runs on central processor unit 6 and information about which is stored in memory 8. In per se known manner the software and the processing unit can run in a remotely placed computer, while the screen and the user are at a different location, by means of a so-called distributed system.

The software which displays information in the information areas is for instance a database program, a diary program, a contact information program and the like. Such programs are able to display information and information objects or data objects, wherein further or background information relating to the information objects is available which can be retrieved. For this purpose an information object is displayed recognizably on a screen, for instance by underlining thereof. If the user of the computer system wishes the further information to be displayed, according to the present invention he/she can cause this information to be displayed in a window or frame to be further determined. For this purpose he makes use of the method according to FIG. 2.

In step 21 (FIG. 2) the display areas or frames or windows are shown. In step 22 the selectable information objects are shown in at least one of the display areas. The user who has determined about which information object he/she wishes to view the further information selects this information object in step 23. In step 24 choosing means are then displayed in the vicinity of the information object. It is possible here to envisage a context menu with several menu options or a set of icons which represent a choice. Such a set of icons can for instance be displayed in the form of a quadrant or in the form of a circle, wherein the placing of an icon indicates the direction in which the information must be displayed or the position of the window in which the information is displayed. Depending on the desired setting of the user, the choosing means such as the context menu or the icons can be displayed automatically when the mouse cursor is placed at the position of the information object, or can be displayed after the user has entered a command to this effect, for instance by means of the right mouse button or a keystroke on the keyboard.

The display area is then chosen in step 25. It is possible here to choose from a display on the left-hand side, the right-hand side, the bottom or the top of the present screen in which the selected information object is displayed.

In step 26 further information is then displayed in the chosen window. This process can be repeated in that information objects with their own further information are for instance also situated in the further information. In this case the user can choose to display, in a window to be chosen, this renewed further information in similar manner as described in the foregoing.

According to a further embodiment, the new window to be displayed can be situated in for instance a second display area of a second screen. In such an embodiment the choosing means can be provided with extra designations which indicate whether the same screen should be used, or a screen other than that in which the information object is displayed. A two-step context menu can for instance be used for this purpose, where in the first step a choice of screen is made and then, once the screen has been chosen, in step 27 a second context menu determines the choice of window within the screen. This option is useful when there is frequent switching of screen. If there is frequent switching of windows within a screen, an extra choice, as to whether the present screen or a new screen must be used for the further information of the information object, can be added by means of a sub-context menu to the context menu as described in the previous embodiment per screen to be chosen which is available as standard within the present screen.

A further alternative is that, in the context menu of a system with two or more screens, all possible choices for each screen are displayed, wherein the number of possible choices times the number of screens determines the number of alternatives to be chosen from the context menu or the icons.

FIG. 3 shows an embodiment in which three sub-windows 31, 32, 33 are displayed on screen 30. The top left window 31 has been made graphically recognizable by means of a V pattern. The right-hand window 33 is made recognizable by means of a + pattern. The bottom left window 32 is made recognizable by means of a triangle pattern. In FIG. 3A the window 32 at bottom left is blank, since this is the window in which an information object 34 is selected. Information objects are displayed by means of underlined rectangles 39, while standard displayed information is displayed by means of non-underlined rectangles. The actually selected information object is displayed by means of an underlined parallelogram 34.

When selecting information object 34, about which display of further information is desired, a context menu 35 is displayed in the form of a small graphic representation of the whole screen, for instance by means of a mouse click. This small display comprises a small display 36 of the upper left window, a small display 37 of the so-called active window 32, as well as a small display 38 of right-hand window 33. In the small displays 36, 37 and 38 is displayed the graphic pattern of the large respective windows. A user who wishes to display the further information of information object 34 can click in intuitive manner on one of the small displays of the large windows, on the basis of which further information of information object 34 will be displayed in the associated window. FIG. 3B shows in similar manner the possibility that the information object is situated in window 31. In this case this window 31 has a blank display and windows 32 and 33 are designated by means of a graphic pattern. After selection of information object 34, the screen-like context menu 35 is displayed, whereafter the user can select the desired window for display of the further information. In similar manner this whole is shown in FIG. 3C, wherein the so-called active window with the data object 34 to be selected is now displayed in the right-hand window. The context menu 35 for this window 33 is likewise displayed. The user can herein make a selection from the small displays 36 an 37 of context menu 35. In these FIGS. 3A-C information objects are designated with 39 and the selected data object is designated with 34.

FIG. 4 shows a corresponding screen layout wherein windows 41, 42 and 43 are numbered 1, 2 and 3 in the title bar of the window. In the quick menus which are shown in the successive figures in the respective windows, a selection can be made from the numbers of the other windows. In FIG. 4A a context menu 45 with menu options 1 and 2 is here shown in window 3, in FIG. 4B a quick menu 45 with menu options 2 and 3 is shown in window 1, and in FIG. 4C a context menu with menu options 1 and 3 is shown in window 2.

Just as in FIG. 3 the windows in context menu 35 are designated with graphic patterns, in an alternative embodiment this can be realized by means of for instance colours. A further embodiment is to give a window a name and display this name in a context menu instead of for instance the numbers of context menus 45. In addition to applying a context menu, the use of a quick menu is also possible.

In a further embodiment the choice can be indicated for displaying the further information by means of an auditive or a voice command. It is for instance possible here to say: “further information relating to information object 34 to window 2”. The program will then display the further information relating to data object 34 in window 2.

The above described embodiments can be varied relative to each other to obtain other embodiments. The rights sought are defined by the appended claims.

1. Device comprising a memory and a processing unit for displaying information on at least one screen, comprising:
first display means for displaying at least two display areas, such as a frame or a window, on the screen,
second display means for displaying inside one of the display areas selectable information objects about which further information is available,
selection means for selecting one of the selectable information objects,
choosing means for choosing a displayed display area and/or screen in which the further information relating to the selected information object will be displayed.

2. Device as claimed in claim 1, wherein the further or background information can be retrieved from the memory by the selection means.

3. Device as claimed in claim 1 or 2, wherein at least one information object is displayed recognizably on the screen.

4. Device as claimed in claim 1, 2 or 3, wherein the display area to be chosen comprises an already opened display area.

5. Device as claimed in claims 1-4, wherein the choosing means comprise means for displaying a context menu.

6. Device as claimed in claims 1-5, wherein the choosing means comprise means for displaying selectable icons.

7. Device as claimed in claims 1-6, wherein a choice can be made, by means of the choosing means, the context menu or the icons, as to in which already displayed display area the further information will be displayed.

8. Device as claimed in claims 1-6, wherein a display area to the right or left adjacently of the current display area is designated by means of the choosing means, the context menu or the icons.

9. Device as claimed in claims 1-6, wherein a display area above or below the current display area is designated by means of the choosing means, the context menu or the icons.

10. Device as claimed in claims 1-9, wherein the choosing means are adapted to interpret auditive or spoken commands.

11. Method for determining a second display area for displaying further information relating to an information object by means of a device comprising a memory and a processing unit for displaying information on at least one screen, comprising steps for:
displaying at least two display areas, such as a frame or a window, on a screen,
displaying inside one of the display areas selectable information objects about which further information is available,
selecting an information object in a first display area,
displaying choosing means,
choosing a display area and/or a screen in which the further information relating to the selectable information object will be displayed,
displaying the further information in the chosen display area.

12. Method as claimed in claim 11, wherein the step for displaying the choosing means comprises steps for displaying a context menu.

13. Method as claimed in claim 11 or 12, wherein the steps for displaying choosing means or for displaying a context menu comprise steps for displaying selectable icons.

14. Method as claimed in one or more of the claims 11-13, comprising steps wherein a choice can be made by means of the choosing means, the context menu, the icons or auditively in which already displayed display area the further information will be displayed.

15. Method as claimed in one or more of the claims 11-13, comprising steps wherein by means of the choosing means, the context menu or the icons a display area is designated adjacently to the right, adjacently to the left, adjacently above or below the current display area.

16. Data carrier comprising a computer program which, when executed by means of a processing unit, can perform a method as claimed in one or more of the claims 11-15.

17. Software for performing a method as claimed in one or more of the claims 11-15 by means of a computer.
